(19) United States
(12) Patent Application Publication
(10) Pub. No.: US 2021/0142512 A1
(43) Pub. Date: May 13, 2021

(54) IMAGE PROCESSING METHOD AND IMAGE PROCESSING APPARATUS

(71) Applicant: OLYMPUS CORPORATION, Tokyo (JP)

(72) Inventor: Jun ANDO, Tokyo (JP)

(73) Assignee: OLYMPUS CORPORATION, Tokyo (JP)

(21) Appl. No.: 17/151,719

(22) Filed: Jan. 19, 2021

Related U.S. Application Data
(63) Continuation of application No. PCT/JP2018/030119, filed on Aug. 10, 2018.

(51) Int. Cl. G06T 7/73; G06K 9/62; G06K 9/32; G06K 9/03

(52) U.S. Cl. CPC G06T 7/73; G06K 9/6232; G06K 9/3241; G06K 2009/6213; G06K 9/03; G06T 2207/10068; G06K 2209/057; G06K 9/6215

(57) ABSTRACT

An image processing apparatus detects a tip of an object from an image. The image processing apparatus includes an image input unit that receives an input of an image; a feature map generation unit that generates a feature map by applying a convolutional operation to the image; a first conversion unit that generates a first output by applying a first conversion to the feature map; a second conversion unit that generates a second output by applying a second conversion to the feature map; and a third conversion unit that generates a third output by applying a third conversion to the feature map. The first output represents information related to a predetermined number of candidate regions defined on the image, the second output indicates a likelihood that a tip of the object is located in the candidate region, and the third output represents information related to an orientation of the tip of the object located in the candidate region.

### CROSS-REFERENCE TO RELATED APPLICATIONS

This application is based upon and claims the benefit of priority from International Application No. PCT/JP2018/030119, filed on Aug. 10, 2018, the entire contents of which is incorporated herein by reference.

### BACKGROUND OF THE INVENTION

### 1. Field of the Invention

The present invention relates to an image processing method and an image processing apparatus.

### 2. Description of the Related Art

In recent years, much attention has been paid to deep learning implemented in a neural network having a deep network layer. For example, patent literature 1 proposes a technology of applying deep learning to a detection process.

In the technology disclosed in patent literature 1, a detection process is realized by learning whether each of a plurality of regions arranged at equal intervals on an image includes a subject of detection, and, if it includes a subject of detection, how the region should be moved or deformed to better fit the subject of detection.
[Non-patent literature 1] Shaoqing Ren, Kaiming He, Ross Girshick and Jian Sun “Faster R-CNN: Towards Real-Time Object Detection with Region Proposal Networks”, Conference on Neural Information Processing Systems (NIPS), 2015

In the detection process for detecting the tip of an object, the orientation of the object, as well as the position thereof, may carry weight in some cases. However, the related-art technology as disclosed in patent literature 1 does not consider the orientation.

### SUMMARY OF THE INVENTION

The present invention addresses the above-described issue, and a general purpose thereof is to provide a technology capable of considering the orientation of an object, as well as the position thereof, in the detection process for detecting the tip of an object.

An image processing apparatus according to an embodiment of the present invention is an image processing apparatus for detecting a tip of an object from an image, including: an image input unit that receives an input of an image; a feature map generation unit that generates a feature map by applying a convolutional operation to the image; a first conversion unit that generates a first output by applying a first conversion to the feature map; a second conversion unit that generates a second output by applying a second conversion to the feature map; and a third conversion unit that generates a third output by applying a third conversion to the feature map. The first output represents information related to a predetermined number of candidate regions defined on the image, the second output indicates a likelihood that a tip of the object is located in the candidate region, and the third output represents information related to an orientation of the tip of the object located in the candidate region.

Another embodiment of the present invention also relates to an image processing apparatus. The image processing apparatus is an image processing apparatus for detecting a tip of an object from an image, including: an image input unit that receives an input of an image; a feature map generation unit that generates a feature map by applying a convolutional operation to the image; a first conversion unit that generates a first output by applying a first conversion to the feature map; a second conversion unit that generates a second output by applying a second conversion to the feature map; and a third conversion unit that generates a third output by applying a third conversion to the feature map. The first output represents information related to a predetermined number of candidate points defined on the image, the second output indicates a likelihood that a tip of the object is located in a neighborhood of the candidate point, and the third output represents information related to an orientation of the tip of the object located in the neighborhood of the candidate point.

Still another embodiment present invention relates to an image processing method. The image processing method is an image processing method for detecting a tip of an object from an image, including: receiving an input of an image; generating a feature map by applying a convolutional operation to the image; generating a first output by applying a first conversion to the feature map; generating a second output by applying a second conversion to the feature map; and generating a third output by applying a third conversion to the feature map. The first output represents information related to a predetermined number of candidate regions defined on the image, the second output indicates a likelihood that a tip of the object is located in the candidate region, and the third output represents information related to an orientation of the tip of the object located in the candidate region.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing the function and the configuration of an image processing apparatus according to the embodiment;

FIG. 2 is a diagram for explaining the effect of considering the reliability of the orientation of the tip of the treatment instrument in determining whether the candidate region includes the tip of the treatment instrument; and

FIG. 3 is a diagram for explaining the effect of considering the orientation of the tip in determining the candidate region that should be deleted.

### DETAILED DESCRIPTION OF THE INVENTION

The invention will now be described by reference to the preferred embodiments. This does not intend to limit the scope of the present invention, but to exemplify the invention.

Hereinafter, the invention will be described based on preferred embodiments with reference to the accompanying drawings.

FIG. 1 is a block diagram showing the function and the configuration of an image processing apparatus 100 according to the embodiment. The blocks depicted here are implemented in hardware such as devices and mechanical apparatus exemplified by a central processing unit (CPU) of a computer and a graphics processing unit (GPU), and in software such as a computer program. FIG. 1 depicts functional blocks implemented by the cooperation of these elements. Therefore, it will be understood by those skilled in the art that these functional blocks may be implemented in a variety of manners by a combination of hardware and software.

A description will be given below of a case where the image processing apparatus 100 is used to detect the tip of a treatment instrument of an endoscope. It would be clear to those skilled in the art that the image processing apparatus 100 can be applied to detection of the tip of other objects, and, more specifically, to detection of the tip of a robot arm, a needle under a microscope, a rod-shaped sport gear, etc.

The image processing apparatus 100 is an apparatus for detecting the tip of a treatment instrument of an endoscope from an endoscopic image. The image processing apparatus 100 includes an image input unit 110, a ground truth input unit 111, a feature map generation unit 112, a region setting unit 113, a first conversion unit 114, a second conversion unit 116, a third conversion unit 118, an integrated score calculation unit 120, a candidate region determination unit 122, a candidate region deletion unit 124, a weight initialization unit 126, a total error calculation unit 128, an error propagation unit 130, a weight updating unit 132, a result presentation unit 133, and a weight coefficient storage unit 134.

A description will first be given of an application step of using the trained image processing apparatus 100 to detect the tip of the treatment instrument from the endoscopic image.

The image input unit 110 receives an input of an endoscopic image from a video processor connected to the endoscope or any of other apparatuses. The feature map generation unit 112 generates a feature map by applying a convolutional operation using a predetermined weight coefficient to the endoscopic image received by the image input unit 110. The weight coefficient is obtained in the learning step described later and is stored in the weight coefficient storage unit 134. In this embodiment, a convolutional neural network (CNN) based on VGG-16 is used for convolutional operation. However, the embodiment is non-limiting, and other CNNs may also be used. For example, a residual network in which identity mapping (IM) is introduced may be used for convolutional operation.

The region setting unit 113 sets a predetermined number of regions (hereinafter, referred to as “initial regions”) at equal intervals on the endoscopic image received by the image input unit 110.

The first conversion unit 114 generates information (first output) related to a plurality of candidate regions respectively corresponding to the plurality of initial regions, by applying the first conversion to the feature map. In this embodiment, information related to the candidate region is information including the amount of position variation required for a reference point (e.g., the central point) of the initial region to approach the tip. Alternatively, the information related to the candidate region may be information including the position and size of the region occupied after moving the initial region to better fit the tip of the treatment instrument. For the first conversion, convolutional operation using a predetermined weight coefficient is used. The weight coefficient is obtained in the learning step described later and is stored in the weight coefficient storage unit 134.

The second conversion unit 116 generates the likelihood (second output) indicating whether the tip of the treatment instrument is located in each of the plurality of initial regions, by applying the second conversion to the feature map. The second conversion unit 116 may generate the likelihood indicating whether the tip of the treatment instrument is located in each of the plurality of candidate regions. For the second conversion, convolutional operation using a predetermined weight coefficient is used. The weight coefficient is obtained in the learning step described later and is stored in the weight coefficient storage unit 134.

The third conversion unit 118 generates information (third output) related to the orientation of the tip of the treatment instrument located in each of the plurality of initial regions, by applying the second conversion to the feature map. The third conversion unit 118 may generate information related to the orientation of the tip of the treatment instrument located in each of the plurality of candidate regions. In this embodiment, the information related to the orientation of the tip of the treatment instrument is a directional vector (vx, vy) extending along the line the tip part extends and starting at the tip of the treatment instrument. For the third conversion, convolutional operation using a predetermined weight coefficient is used. The weight coefficient is obtained in the learning step described later and is stored in the weight coefficient storage unit 134.

The integrated score calculation unit 120 calculates an integrated score of each of the plurality of initial regions or each of the plurality of candidate regions, based on the likelihood generated by the second conversion unit 116 and the reliability of the information related to the orientation of the tip of the treatment instrument generated by the third conversion unit 118. In this embodiment, the “reliability” of the information related to the orientation is the magnitude of the directional vector of the tip. The integrated score calculation unit 120 calculates an integrated score (scoreₜₒₜₐₗ) by, in particular, a weighted sum of the likelihood and the reliability of the orientation, and, more specifically, according to the expression (1) below.

scoreₜₒₜₐₗ=score₂+\sqrt{vₓ²+v_{y}²}×w₃ (1)

where score₂ denotes the likelihood, and w3 denotes the weight coefficient by which the magnitude of the directional vector is multiplied.

The candidate region determination unit 122 determines whether the tip of the treatment instrument is found in each of the plurality of candidate regions based on the integrated score and identifies the candidate region in which the tip of the treatment instrument is (estimated to be) located. More specifically, the candidate region determination unit 122 determines that the tip of the treatment instrument is located in the candidate region for which the integrated score is equal to or greater than a predetermined threshold value.

FIG. 2 is a diagram for explaining the effect of using an integrated score in determining whether the candidate region includes the tip of the treatment instrument, i.e., the effect of considering, for determination of the candidate region, the magnitude of the directional vector of the tip of the treatment instrument as well as the likelihood. In this example, a treatment instrument 10 is forked and has a protrusion 12 in a branching part that branches to form a fork. Since the protrusion 12 has a shape similar in part to the tip of the treatment instrument, the output likelihood of a candidate region 20 including the protrusion 12 may be high. If a determination as to whether the candidate region includes a tip 14 of the treatment instrument 10 is made only by using the likelihood in this case, the candidate region 20 could be determined as a candidate region where the tip 14 of the treatment instrument 10 is located, i.e., the protrusion 12 of the branching part could be falsely detected as the tip of the treatment instrument. According to the embodiment, on the other hand, whether a candidate region includes the tip 14 of the treatment instrument 10 is determined by considering the magnitude of the directional vector as well as the likelihood. The magnitude of the directional vector of the protrusion 12 of the branching part, which is not the tip 14 of the treatment instrument 10, tends to be small. Therefore, the precision of detection is improved by considering the magnitude of the directional vector as well as the likelihood.

Referring back to FIG. 1, the candidate region deletion unit 124 calculates, when it is determined by the candidate region determination unit 122 that the tip of the treatment instrument is located in a plurality of candidate regions, a similarity between those plurality of candidate regions. When the similarity is equal to or greater than a predetermined threshold value, and when the orientations of the tips of the treatment instrument associated with the plurality of candidate regions match substantially, it is considered that the same tip is detected. Therefore, the candidate region deletion unit 124 maintains the candidate region for which the associated integrated score is higher and deletes the candidate region for which the score is lower. When the similarity is less than the predetermined threshold value, on the other hand, or when the orientations of the tips of the treatment instrument associated with the plurality of candidate regions are mutually different, it is considered that tips are detected in the candidate regions so that the candidate region deletion unit 124 maintains all of the candidate regions without deleting them. That the orientations of the tips of the treatment instrument match substantially means that the orientations of the respective tips are parallel or that the acute angle formed by the orientations of the respective tips is equal to or less than a predetermined threshold value. In further accordance with the embodiment, the intersection over union between candidate regions is used as indicating the similarity. In other words, the more the candidate regions overlap each other, the higher the similarity. The index of similarity is not limited to this. For example, the inverse of the distance between candidate regions may be used.

FIG. 3 is a diagram for explaining the effect of considering the orientation of the tip in determining the candidate region that should be deleted. In this example, the tip of a first treatment instrument 30 is detected in the first candidate region 40, and the tip of a second treatment instrument 32 is detected in the second candidate region 42. When the tip of the first treatment instrument 30 and the tip of the second treatment instrument 32 are proximate to each other, and, ultimately, when the first candidate region 40 and the second candidate region 42 are proximate to each other, a determination may be made to delete one of the candidate regions if the determination on deletion is based only on the similarity, regardless of the fact that the first candidate region 40 and the second candidate region 42 are candidate regions in which the tips of different treatment instruments are detected. In other words, a determination may be made that the same tip is detected in the first candidate region 40 and the second candidate region 42 so that one of the candidate regions may be deleted. In contrast, the candidate region deletion unit 124 according to the embodiment determines whether a candidate region should be deleted by considering the orientation of the tip as well as the similarity. Therefore, even if the first candidate region 40 and the second candidate region 42 are proximate to each other and the similarity is high, an orientation D1 of the tip of the first treatment instrument 30 and an orientation D2 of the tip of the second treatment instrument 32 differ so that neither of the candidate regions is deleted, and the tips of the first treatment instrument 30 and the second treatment instrument 32 proximate to each other can be detected.

Referring back to FIG. 1, the result presentation unit 133 presents the result of detection of the treatment instrument to, for example, a display. The result presentation unit 133 presents the candidate region determined by the candidate region determination unit 122 as containing the tip of the treatment instrument and maintained without being deleted by the candidate region deletion unit 124 as the candidate region in which the tip of the treatment instrument is detected.

A description will now be given of a learning (optimizing) step of learning the weight coefficients used in the respective convolutional operations performed by the image processing apparatus 100.

The weight initialization unit 126 initializes the weight coefficients subject to learning and used in the processes performed by the feature map generation unit 112, the first conversion unit 114, the second conversion unit 116, and the third conversion unit 118. More specifically, the weight initialization unit 126 uses a normal random number with an average of 0 and a standard deviation of wscale/√(cᵢ×k×k) for initialization, where wscale denotes a scale parameter, cᵢ denotes the number of input channels of the convolutional layer, and k denotes the convolutional kernel size. A weight coefficient learned by a large-scale image DB different from the endoscopic image DB used in the learning in this embodiment may be used as the initial value of the weight coefficient. This allows the weight coefficient to be learned even if the number of endoscopic images used for learning is small.

The image input unit 110 receives an input of an endoscopic image for learning from, for example, a user terminal or other apparatus. The ground truth input unit 111 receives the ground truth corresponding to the endoscopic image for learning from the user terminal or other apparatus. The amount of position variation required for the reference points (central points) of the plurality of initial regions set by the region setting unit 113 in the endoscopic image for learning to be aligned with the tip of the treatment instrument, i.e., the amount of position variation indicating how each of the plurality of initial regions should be moved to approach the tip of the treatment instrument, is used as the ground truth corresponding to the output from the process performed by the first conversion unit 114. A binary value indicating whether the tip of the treatment instrument is located in the initial region is used as the ground truth corresponding to the output from the process performed by the second conversion unit 116. A unit directional vector indicating the orientation of the tip of the treatment instrument located in the initial region is used as the ground truth corresponding to the third conversion.

The process in the learning step performed by the feature map generation unit 112, the first conversion unit 114, the second conversion unit 116, and the third conversion unit 118 is the same as the process in the application step.

The total error calculation unit 128 calculates an error in the process as a whole based on the outputs of the first conversion unit 114, the second conversion unit 116, and the third conversion unit 118 and the ground truth data corresponding to the outputs. The error propagation unit 130 calculates errors in the respective processes in the feature map generation unit 112, the first conversion unit 114, the second conversion unit 116, and the third conversion unit 118, based on the total error.

The weight updating unit 132 updates the weight coefficients used in the respective convolutional operations in the feature map generation unit 112, the first conversion unit 114, the second conversion unit 116, and the third conversion unit 118, based on the errors calculated by the error propagation unit 130. For example, stochastic gradient descent method may be used to update the weight coefficients based on the errors.

A description will now be given of the operation in the application process of the image processing apparatus 100 configured as described above. The image processing apparatus 100 first sets a plurality of initial regions in a received endoscopic image. Subsequently, the image processing apparatus 100 generates a feature map by applying a convolutional operation to the endoscopic image, generates information related to a plurality of candidate regions by applying the first operation to the feature map, generates the likelihood that the tip of the treatment instrument is located in each of the plurality of initial regions by applying the second operation to the feature map, and generates information related to the orientation of the tip of the treatment instrument located in each of the plurality of initial regions by applying the third operation to the feature map. The image processing apparatus 100 calculates an integrated score of the respective candidate regions and determines the candidate region for which the integrated score is equal to or greater than a predetermined threshold value as the candidate region in which the tipoff the treatment instrument is detected. Further, the image processing apparatus 100 calculates the similarity among the candidate regions thus determined and deletes, based on the similarity, those of the candidate regions in which the same tip is detected and for which the likelihood is low. Lastly, the image processing apparatus 100 presents the candidate region that remains without being deleted as the candidate region in which the tip of the treatment instrument is detected.

According to the image processing apparatus 100 described above, information related to the orientation of the tip is considered for determination of the candidate region in which the tip of the treatment instrument is located, i.e., for detection of the tip of the treatment instrument. In this way, the tip of the treatment instrument can be detected with higher precision than in the related art.

Described above is an explanation of the present invention based on an exemplary embodiment. The embodiment is intended to be illustrative only and it will be understood by those skilled in the art that various modifications to combinations of constituting elements and processes are possible and that such modifications are also within the scope of the present invention.

In one variation, the image processing apparatus 100 may set a predetermined number of points (hereinafter, “initial points”) at equal intervals on the endoscopic image, generate information (first output) related to a plurality of candidate points respectively corresponding to the plurality of initial points, by applying the first conversion to the feature map, generate the likelihood (second output) that the tip of the treatment instrument is located in the neighborhood of (e.g., within a predetermined range from each point) each of the initial points or each of the plurality of candidate points, by applying the second conversion, and generate information (third information) related to the orientation of the tip of the treatment instrument located in the neighborhood of each of the plurality of initial points or the plurality of candidate points, by applying the third conversion.

In the embodiments and the variation, the diagnostic imaging support system may include a processor and a storage such as a memory. The functions of the respective parts of the processor may be implemented by individual hardware, or the functions of the parts may be implemented by integrated hardware. For example, the processor could include hardware, and the hardware could include at least one of a circuit for processing digital signals or a circuit for processing analog signals. For example, the processor may be configured as one or a plurality of circuit apparatuses (e.g., IC, etc.) or one or a plurality of circuit devices (e.g., a resistor, a capacitor, etc.) packaged on a circuit substrate. The processor may be, for example, a central processing unit (CPU). However, the processor is not limited to a CPU. Various processors may be used. For example, a graphics processing unit (GPU) or a digital signal processor (DSP) may be used. The processor may be a hardware circuit comprised of an application specific integrated circuit (ASIC) or a field-programmable gate array (FPGA). Further, the processor may include an amplifier circuit or a filter circuit for processing analog signals. The memory may be a semiconductor memory such as SRAM and DRAM or may be a register. The memory may be a magnetic storage apparatus such as a hard disk drive or an optical storage apparatus such as an optical disk drive. For example, the memory stores computer readable instructions. The functions of the respective parts of the diagnostic imaging support system are realized as the instructions are executed by the processor. The instructions may be instructions of an instruction set forming the program or instructions designating the operation of the hardware circuit of the processor.

Further, in the embodiments and the variation, the respective processing units of the diagnostic imaging support system may be connected by an arbitrary format or medium of digital data communication such as communication network. Examples of the communication network include, for example, LAN, WAN, computers and networks forming the Internet.

What is claimed is:

1. An image processing apparatus for detecting a tip of an object from an image, comprising: a processor comprising hardware, wherein the processor is configured to:
receive an input of an image;
generate a feature map by applying a convolutional operation to the image;
generate a first output by applying a first conversion to the feature map;
generate a second output by applying a second conversion to the feature map; and
generate a third output by applying a third conversion to the feature map, wherein
the first output represents information related to a predetermined number of candidate regions defined on the image,
the second output indicates a likelihood that a tip of the object is located in the candidate region, and
the third output represents information related to an orientation of the tip of the object located in the candidate region.

2. An image processing apparatus for detecting a tip of an object from an image, comprising: a processor comprising hardware, wherein the processor is configured to:
receive an input of an image;
generate a feature map by applying a convolutional operation to the image;
generate a first output by applying a first conversion to the feature map;
generate a second output by applying a second conversion to the feature map; and
generate a third output by applying a third conversion to the feature map, wherein
the first output represents information related to a predetermined number of candidate points defined on the image,
the second output indicates a likelihood that a tip of the object is located in a neighborhood of the candidate point, and
the third output represents information related to an orientation of the tip of the object located in the neighborhood of the candidate point.

3. The image processing apparatus according to claim 1, wherein
the object is a treatment instrument of an endoscope.

4. The image processing apparatus according to claim 1, wherein
the object is a robot arm.

5. The image processing apparatus according to claim 1, wherein
the information related to the orientation includes an orientation of the tip of the object and information related to a reliability of the orientation.

6. The image processing apparatus according to claim 5, wherein
the processor calculates an integrated score of the candidate region, based on the likelihood indicated by the second output and the reliability of the orientation.

7. The image processing apparatus according to claim 6, wherein
the information related to the reliability of the orientation included in the information related to the orientation is a magnitude of a directional vector indicating the orientation of the tip of the object, and
the integrated score is a weighted sum of the likelihood and the magnitude of the directional vector.

8. The image processing apparatus according to claim 6, wherein
the processor determines the candidate region in which the tip of the object is located, based on the integrated score.

9. The image processing apparatus according to claim 1, wherein
the information related to the candidate region includes an amount of position variation required to cause a reference point in an associated initial region to approach the tip of the object.

10. The image processing apparatus according to claim 1, wherein
the processor calculates a similarity between a first candidate region and a second candidate region of the candidate regions and determines whether to delete one of the first candidate region and the second candidate region, based on the similarity and on the information related to the orientation associated with the first candidate region and the second candidate region.

11. The image processing apparatus according to claim 10, wherein
the similarity is an inverse of a distance between the first candidate region and the second candidate region.

12. The image processing apparatus according to claim 10, wherein
the similarity is an intersection over union between the first candidate region and the second candidate region.

13. The image processing apparatus according to claim 1, wherein
the processor is configured to:
apply a convolutional operation to the feature map in generation of the first output, generation of the second output, and generation of the third output.

14. The image processing apparatus according to claim 13, wherein
the processor is configured to:
calculate an error in a process as a whole from outputs in the generation of the first output, the generation of the second output, and the generation of the third output and from the ground truth prepared in advance;
calculate errors in respective processes, which include generation of the feature map, the generation of the first output, the generation of the second output, and the generation of the third output, based on the error of the process as a whole, and
update a weight coefficient used in the convolutional operation in the respective processes, based on the errors in the respective processes.

15. An image processing method for detecting a tip of an object from an image, comprising:
receiving an input of an image;
generating a feature map by applying a convolutional operation to the image;
generating a first output by applying a first conversion to the feature map;
generating a second output by applying a second conversion to the feature map; and
generating a third output by applying a third conversion to the feature map, wherein
the first output represents information related to a predetermined number of candidate regions defined on the image,
the second output indicates a likelihood that a tip of the object is located in the candidate region, and
the third output represents information related to an orientation of the tip of the object located in the candidate region.

16. A non-transitory computer readable medium encoded with a program for detecting a tip of an object from an image, the program comprising:
receiving an input of an image;
generating a feature map by applying a convolutional operation to the image;
generating a first output by applying a first conversion to the feature map;
generating a second output by applying a second conversion to the feature map; and
generating a third output by applying a third conversion to the feature map, wherein
the first output represents information related to a predetermined number of candidate regions defined on the image,
the second output indicates a likelihood that a tip of the object is located in the candidate region, and
the third output represents information related to an orientation of the tip of the object located in the candidate region.
